(19) United States
(12) Patent Application Publication
(10) Pub. No.: US 2016/0340509 A1
(43) Pub. Date: Nov. 24, 2016

(54) Polyolefin Copolymers as Color Enhancers in Polyamides

(71) Applicant: BASF SE, Ludwigshafen (DE)

(72) Inventors: Christian Schmidt, Ludwigshafen (DE); Florian Richter, Mannheim (DE); Joachim Clauss, Darmstadt (DE); Andreas Wollny, Freinsheim (DE); Philippe Desbois, Edingen-Neckarhausen (DE); Faissal-Ali El-Toufaili, Ludwigshafen (DE); Achim Stammer, Freinsheim (DE); Stefan Schwiegk, Neustadt (DE)

(73) Assignee: BASF SE, Ludwigshafen (DE)

(21) Appl. No.: 15/113,854

(22) PCT Filed: Jan. 26, 2015
(86) PCT No.: PCT/EP2015/051476

§ 371 Date: Jul. 25, 2016

(30) Foreign Application Priority Data
Jan. 27, 2014 (EP) 14152712.7

(51) Int. Cl. C08L 77/06; C08L 77/02

(52) U.S. Cl. CPC C08L 77/06; C08L 77/02

(57) ABSTRACT

The present invention relates to the use of polyolefin copolymers A) for reducing color changes during the heating of polymer compositions which contain at least one thermoplastic polyamide B).

### BACKGROUND OF THE INVENTION

The present invention relates to the use of polyolefin copolymers for reducing color changes in the course of heating of polymer compositions comprising at least one thermoplastic polyamide, to the use of these polymer compositions and to a method for reducing color changes in polyamide-containing polymer compositions.

### PRIOR ART

Polyamides are one of the polymers produced on a large scale globally and, in addition to the main fields of use in films, fibers and materials, serve for a multitude of further end uses. Among the polyamides, polyamide-6 (polycaprolactam) and polyamide-6,6 (Nylon, polyhexamethyleneadipamide) are the polymers prepared in the largest volumes. A further important group of polyamides is that of semicrystalline or amorphous thermoplastic semiaromatic polyamides, which have found a wide range of use as important industrial plastics. They are especially notable for their high thermal stability and are also referred to as high-temperature polyamides (HTPA). Polyamides are typically processed by the known shaping methods for thermoplastics such as injection molding, extrusion and film blowing. However, high-temperature polyamides have comparatively high melting points, for example about 290° C. or higher, whereas aliphatic polyamides such as polyamide-6,6 melt at about 260 to 265° C.

Through addition of additives, it is possible to improve the mechanical properties of polyamides. It is known that the addition of rubbers (often also referred to as elastomers, elastomeric polymers) improves the impact resistance of polyamides. U.S. Pat. No. 5,436,294 describes impact-modified polyphthalamide compounds comprising, as impact modifier, maleic anhydride-modified block copolymers composed of styrene blocks and polyolefin blocks. WO 2005/121249 describes polyamide molding compositions having improved mobility and impact resistance, comprising a semicrystalline thermoplastic polyamide and a copolymer formed from an olefin with (meth)acrylic esters of aliphatic alcohols. WO 2011/051123 describes thermal aging-resistant polyamides comprising iron powder as heat stabilizer and elastomeric polymers as impact modifier. The elastomeric polymers are polyolefin copolymers preferably formed from at least two of the following monomers: ethylene, propylene, butadiene, isobutene, isoprene, chloroprene, vinyl acetate, styrene, acrylonitrile and acrylic or methacrylic esters having 1 to 18 carbon atoms in the alcohol component.

No use of polyolefin copolymers for improving color in polyamides has been described in the prior art.

If amorphous polyamides are exposed to relatively high temperatures above their glass transition temperature, or semicrystalline polyamides to relatively high temperatures in the region of their melting temperature, there is generally occurrence of yellowing or browning. This discoloration can be expressed, for example, by the yellowness index (YI). The discoloration is disadvantageous since it distorts the desired hue of the polyamide compositions (lack of color fidelity) or the use of greater amounts of costly colorants (higher coloring costs).

To reduce the yellowing and lightening of polyamides, EP 1375578 and WO 2006/135841 propose the use of titanium dioxide. However, the addition of titanium dioxide leads to a decrease in the impact resistance of polyamides.

WO 2009/056583 describes flame-retardant polyamide compositions having improved color stability, comprising phosphine salts, phenol stabilizers and/or phosphite and phosphonite stabilizers. The polyamide compositions show a distinct intrinsic color.

WO 2000/078869 describes stabilizer compositions comprising copper(I) halide and alkali metal halide for use in high-temperature polyamides. Polyamides of this kind also show distinct yellowing.

It was an object of the present invention to provide polymer compositions comprising a thermoplastic polyamide with an improved yellowness index. In addition, the polymer compositions were to have improved whiteness. It was a further object to provide polymer compositions having low intrinsic color not achieved at the cost of other advantageous properties, for example mechanical properties such as toughness.

It has been found that, surprisingly, this object is achieved by the inventive use of a polyolefin copolymer A) in a polymer composition comprising a thermoplastic polyamide B).

### SUMMARY OF THE INVENTION

This invention firstly provides for the use of polyolefin copolymers A) for reducing color changes of polymer compositions comprising at least one thermoplastic polyamide B), wherein the polyolefin copolymer A) comprises at least one ethylenically unsaturated monomer Ma and at least one monoethylenically unsaturated monomer Mb in copolymerized form, wherein monomer Ma is selected from
C₂-C₁₀-alkenes; and
vinylaromatic compounds of the formula I

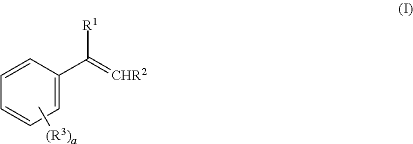

in which
R¹ and R² are each independently selected from hydrogen, C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl;
R³ is C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl; and
a is 0, 1 or 2;
   and
   monomer Mb is selected from
monoethylenically unsaturated C₃-C₂₃ monocarboxylic acids;
esters of monoethylenically unsaturated C₃-C₂₃ monocarboxylic acids with compounds of formula (II)

R⁴—OH (II),
in which
R⁴ is C₁-C₁₀-alkyl, C₃-C₁₂-cycloalkyl or phenyl, where C₃-C₁₂-cycloalkyl and phenyl are unsubstituted or mono- or polysubstituted by C₁-C₁₀-alkyl;
N—C₁-C₈-alkyl-substituted amides of monoethylenically unsaturated C₃-C₂₃ monocarboxylic acids;
monoethylenically unsaturated C₄-C₂₀ dicarboxylic acids;
monoethylenically unsaturated C₄-C₂₀ dicarboxylic anhydrides;
monoesters of monoethylenically unsaturated C₄-C₂₀ dicarboxylic acids with compounds of formula (II);
diesters of monoethylenically unsaturated C₄-C₂₀ dicarboxylic acids with compounds of formula (II);
vinyl esters of C₁-C₁₀ monocarboxylic acids;
allyl esters of C₁-C₁₀ monocarboxylic acids;
monoethylenically unsaturated oxiranes of the formula (III); and
monoethylenically unsaturated oxiranes of the formula (IV)

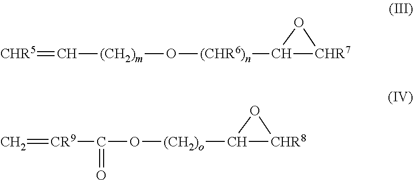

in which
R⁵, R⁶, R⁷, R⁸ and R⁹ are each independently selected from hydrogen and C₁-C₆-alkyl;
m is an integer from 0 to 20;
n is an integer from 0 to 10; and
o is an integer from 0 to 5.

The invention further provides for use in films, monofilaments, fibers, yarns or textile fabrics.

The invention further provides for use in electrical and electronic components and for high-temperature automotive applications.

The invention further provides for use in soldering operations under lead-free conditions (lead free soldering), for production of plug connectors, microswitches, microbuttons and semiconductor components, especially reflector housings of light-emitting diodes (LEDs).

The invention further provides a method of reducing color changes in polymer compositions, wherein
(i) a polymer composition comprising at least one thermoplastic polyamide B) is provided; and
(ii) a polyolefin copolymer A) as defined above is incorporated into the polymer composition.

The invention further provides a method of using polyolefin copolymers A) as defined above in a polymer composition comprising at least one thermoplastic polyamide B) for reducing color changes in the course of heating of the polymer composition.

### DESCRIPTION OF THE INVENTION

Through the inventive use of the polyolefin component A), it is possible to prevent or at least reduce production- and/or processing-related discoloration of polyamide-containing polymer compositions. The resultant polymer compositions thus have at least one of the following advantages:
the polyamide-containing polymer compositions have an improved yellowness index YI (to ASTM D 1925);
the polyamide-containing polymer compositions have an improved L* value in the CIELAB color space (high whiteness);

in each case in comparison with a polyamide-containing polymer composition which does not comprise any polyolefin component A). In addition, the polymer compositions have improved mechanical properties, for example high toughness. Through use of the polyolefin component A) in a polyamide-containing polymer composition, it is therefore generally possible to dispense with the additional use of an impact modifier.

In the context of the present invention, the expression C₁-C₁₀-alkyl encompasses linear and branched alkyl groups having 1 to 4, to 6, to 8 or to 10 carbon atoms, for example methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, 3-heptyl, 2-ethylpentyl, 1-propylbutyl, n-octyl, 2-ethylhexyl etc.

In the context of the present invention, the expression C₂-C₂₂-alkenyl encompasses monounsaturated linear or branched hydrocarbyl radicals having 2 to 22 carbon atoms and one double bond in any position, e.g. C₃-C₆-alkenyl such as 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, etc.

In the context of the present invention, the expression C₃-C₁₂-cycloalkyl encompasses monocyclic, bicyclic and tricyclic saturated hydrocarbyl groups having 3 to 12 carbon ring members. Examples of monocyclic saturated hydrocarbyl groups having 3 to 8 and preferably 3 to 6 carbon ring members are cyclopropyl, cyclobutyl, cyclopentyl, cyclohexyl, cycloheptyl and cyclooctyl. Examples of bicyclic saturated hydrocarbyl groups having 5 to 10 carbon ring members are bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl and bicyclo[4.4.0]decyl. Adamantyl is an example of a tricyclic saturated hydrocarbon.

In the context of the present invention, the expression C₅-C₁₂-cycloalkenyl encompasses monocyclic, bicyclic and tricyclic monounsaturated hydrocarbyl groups having 5 to 12 carbon ring members. Examples of monocyclic monounsaturated hydrocarbyl groups having 5 to 12 and preferably 5 to 8 carbon ring members are cyclopentenyl, cyclohexenyl, cycloheptenyl and cyclooctenyl. Examples of bicyclic monounsaturated hydrocarbyl groups having 5 to 12 carbon ring members are bicyclo[2.2.1]hept-2-enyl, bicyclo[2.2.2]oct-2-enyl, bicyclo[3.3.0]oct-2-enyl and bicyclo[4.4.0]dec-2-enyl.

In the context of the present invention, the expression “dicarboxylic acid” encompasses compounds having two carboxyl groups (—COOH). Carboxylic acids having only one carboxyl group are referred to as monocarboxylic acid.

In the context of the present invention, the term “copolymer” encompasses polymers formed from two or more, for example 3 or 4, different monomers.

The polyamides are designated in the context of the invention using abbreviations, some of which are customary in the art, which consist of the letters PA followed by numbers and letters. Some of these abbreviations are standardized in DIN EN ISO 1043-1. Polyamides which can be derived from aminocarboxylic acids of the H₂N—(CH₂)ₓ—COOH type or the corresponding lactams are identified as PA Z where Z denotes the number of carbon atoms in the monomer. For example, PA 6 represents the polymer of ε-caprolactam or of ω-aminocaproic acid. Polyamides derivable from diamines and dicarboxylic acids of the H₂N—(CH₂)ₓ—NH₂ and HOOC—(CH₂)_{y}—COOH types are identified as PA Z1Z2 where Z1 denotes the number of carbon atoms in the diamine and Z2 the number of carbon atoms in the dicarboxylic acid. Copolyamides are designated by listing the components in the sequence of their proportions, separated by slashes. For example, PA 66/610 is the copolyamide of hexamethylenediamine, adipic acid and sebacic acid. For monomers having an aromatic or cycloaliphatic group, the following letter abbreviations are used: T=terephthalic acid, I=isophthalic acid, MXDA=m-xylylenediamine, IPDA=isophoronediamine, PACM=4,4′-methylenebis(cyclohexylamine), MACM=2,2′-dimethyl-4,4′-methylenebis(cyclohexylamine).

The expression “amorphous polyamide” encompasses (co)polyamides which do not exhibit any change in phase and have only one glass transition temperature (Tg).

The expression “semicrystalline polyamide” encompasses (co)polyamides which have both a glass transition temperature (Tg) and a melting temperature (Tm).

Glass transition temperatures (Tg) and melting temperatures (Tm) can be determined by means of differential scanning calorimetry (DSC). The determination can be effected in a manner known per se (DIN EN ISO 11357, Parts 1 to 3).

Hereinafter, some compounds which can derive from acrylic acid and methacrylic acid are abbreviated by insertion of the syllable “(meth)” into the compound derived from acrylic acid.

The color properties of the polymer composition are evaluated by the a,b color coordinate system, which is also referred to as the CIELAB L*,a*,b* system. If a color is defined in CIE L*a*b*, L* describes the brightness, a* the red/green value and b* the yellow/blue value. The brightness of a color is the tendency of the color to white or black. A light color has a high brightness, a dark color a low brightness. The brightness changes in vertical direction from 0 (black) to 100 (white). At the periphery of the color wheel are the pure hues with high saturation. Toward the inside, the saturation decreases as far as the axis, where it is zero (achromatic, gray). Complementary colors are opposite one another. In the CIE L*a*b* model, all hues of the same brightness are on a circular flat plane on which the a and b axes are present at right angles to one another. Positive a values are reddish, negative a values greenish, positive b values yellowish and negative b values bluish.

### Polyolefin Copolymer A)

The polyolefin copolymer A) used in accordance with the invention comprises one or more monoethylenically unsaturated monomers Ma in copolymerized form.

Suitable monomers Ma are linear and branched C₂-C₁₀-alkenes. Preference is given to alkenes having 2 to 8 carbon atoms and one double bond in any position, such as ethene, propene, butene, pentene, hexene and octene. Especially preferred are alkenes having 2 to 8 carbon atoms and a terminal double bond. Among these, preference is given to ethene, propene, 1-butene, 1-pentene, 3-methyl-1-pentene, 1-hexene, 1-octene and mixtures thereof. Especially preferred are ethene, propene, 1-butene and mixtures thereof. Likewise preferred are monomers Ma selected at least from monomers Ma1 and Ma2 and mixtures thereof. Monomer Ma1 is a C₂-C₄-alkene such as ethane, propene and 1-butene. Monomer Ma2 is a C₅-C₁₀-alkene, preferably 1-octene.

Suitable monomers Ma are additionally vinylaromatic compounds of the formula (I)

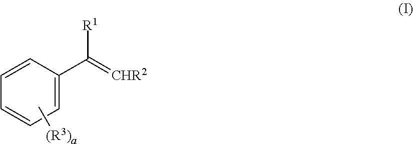

in which
R¹ and R² are each independently selected from hydrogen, C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl;
R³ is C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl; and
a is 0, 1 or 2.

Preferred compounds (I) are those in which R¹, and R² are each independently selected from hydrogen and C₁-C₄-alkyl. R³, if present, is preferably C₁-C₄-alkyl. a is preferably 0 or 1. In the vinylaromatic compounds of the formula (I), R¹ is especially hydrogen or methyl. R² is especially hydrogen. a is especially 0.

Very particularly preferred monomers Ma are ethene, propene, 1-butene and mixtures thereof.

Preferably, the polyolefin copolymer A) has a content of monomer Ma of 50% and 99% by weight, preferably 55% to 95% by weight.

The polyolefin copolymer A) comprises one or more monoethylenically unsaturated monomers Mb in copolymerized form.

Suitable monomers Mb are monoethylenically unsaturated C₃-C₂₃ monocarboxylic acids. Suitable monoethylenically unsaturated C₃-C₂₃ monocarboxylic acids are monocarboxylic acids having a linear or branched alkenyl radical having 2 to 22 carbon atoms.

Among the monoethylenically unsaturated C₃-C₂₃ monocarboxylic acids having a linear or branched alkenyl radical having 2 to 22 carbon atoms, preference is given to C₃-C₂₃ monoethylenically unsaturated monocarboxylic acids of the formula (V)

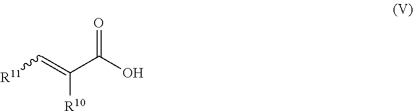

in which
R¹⁰ is selected from hydrogen and
C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl;
   R¹¹ is selected from hydrogen and
C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl.

In a preferred embodiment, R¹⁰ is hydrogen or C₁-C₄-alkyl such as methyl, ethyl, n-propyl, isopropyl, n-butyl, isobutyl, sec-butyl and tert-butyl, especially methyl or ethyl, very particularly hydrogen or methyl.

In another preferred embodiment, R¹¹ is hydrogen or C₁-C₄-alkyl such as methyl, ethyl, n-propyl, isopropyl, n-butyl, isobutyl, sec-butyl and tert-butyl, especially hydrogen or methyl and very particularly hydrogen.

Among these, particular preference is given to monoethylenically unsaturated C₃-C₆ monocarboxylic acids. Examples of these are acrylic acid, methacrylic acid, ethacrylic acid, crotonic acid and isocrotonic acid. Very particularly preferred monoethylenically unsaturated C₃-C₆ monocarboxylic acids are acrylic acid and methacrylic acid.

Additionally suitable are monoethylenically unsaturated monocarboxylic acids having a cycloaliphatic radical, where the carboxyl group is bonded to a ring carbon atom of the cycloaliphatic radical. Useful cycloaliphatic radicals include monocyclic and bicyclic radicals. The cycloaliphatic radical comprises a total of 5 to 22 carbon atoms. The cycloaliphatic radical may be substituted by further aliphatic groups, especially alkyl groups, more preferably 1, 2 or 3 C₁-C₄-alkyl groups. More particularly, the cycloaliphatic radical is C₅-C₁₂-cycloalkenyl which is unsubstituted or bears 1, 2 or 3 C₁-C₄-alkyl groups.

Suitable monomers Mb are additionally the esters of monoethylenically unsaturated C₃-C₂₃ monocarboxylic acids with compounds of the formula (II)

R⁴—OH (II),

in which
R⁴ is C₁-C₁₀-alkyl, C₃-C₁₂-cycloalkyl or phenyl, where C₃-C₁₂-cycloalkyl and phenyl are unsubstituted or mono- or polysubstituted by C₁-C₁₀-alkyl.

The parent monoethylenically unsaturated C₃-C₂₃ monocarboxylic acid of the esters is preferably a monoethylenically unsaturated monocarboxylic acid having a linear or branched alkyl radical having 2 to 22 carbon atoms or a monoethylenically unsaturated monocarboxylic acid having a cycloaliphatic group having 5 to 22 carbon atoms, as described above.

Preference is given to esters of the aforementioned monoethylenically unsaturated C₃-C₂₃ monocarboxylic acids of the formula (V) with compounds of the formula (II). These esters are referred to hereinafter as carboxylic esters of the general formula (VI)

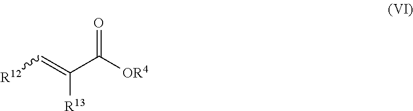

in which
R⁴ is selected from
C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, 2-n-propylheptyl, n-decyl; especially methyl, ethyl, n-butyl, 2-ethylhexyl or 2-n-propylheptyl; and
C₃-C₁₂ cycloalkyl such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl;
   R¹² is selected from hydrogen and
C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, 2-n-propylheptyl, n-decyl; more preferably C₁-C₄-alkyl such as methyl, ethyl, n-propyl, isopropyl, n-butyl, isobutyl, sec-butyl and tert-butyl; especially methyl.
   R¹³ is selected from hydrogen and
C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; more preferably C₁-C₄-alkyl such as methyl, ethyl, n-propyl, isopropyl, n-butyl, isobutyl, sec-butyl and tert-butyl; especially methyl and n-butyl.

In a preferred embodiment of the invention, R⁴ is methyl, ethyl, n-butyl, 2-n-propylheptyl or 2-ethylhexyl.

In a further preferred embodiment of the invention, R¹² is hydrogen.

In a preferred embodiment of the invention, R¹³ is hydrogen or methyl. Most preferably, R¹³ is hydrogen.

In a further preferred embodiment of the invention, R¹² and R¹³ are hydrogen.

Particular preference is given to esters of a monoethylenically unsaturated linear or branched aliphatic C₃-C₆ monocarboxylic acid with C₁-C₁₀-alkanols. Examples of these are methyl (meth)acrylate, ethyl (meth)acrylate, n-butyl (meth)acrylate, 2-ethylhexyl (meth)acrylate and 2-(n-propyl)heptyl (meth)acrylate.

Suitable monomers Mb are additionally N—C₁-C₈-alkyl-substituted amides of monoethylenically unsaturated C₃-C₂₃ monocarboxylic acids, especially N—C₁-C₈-alkyl-substituted amides of monoethylenically unsaturated linear or branched C₃-C₂₃ monocarboxylic acids of the formula (V).

Suitable monomers Mb are additionally monoethylenically unsaturated C₄-C₂₀ dicarboxylic acids. Useful monoethylenically unsaturated C₄-C₂₀ dicarboxylic acids are dicarboxylic acids having a linear or branched alkenyl radical having 2 to 18 carbon atoms. Among these, preference is given to monoethylenically unsaturated C₄-C₂₀ dicarboxylic acids of the formula (VII)

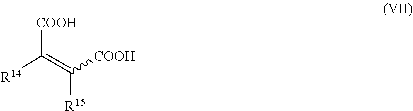

in which
R¹⁴ and R¹⁵ are each independently selected from hydrogen and C₁-C₈-alkyl, preferably selected from hydrogen and C₁-C₆-alkyl.

In a preferred embodiment of the invention, in the compounds of the formula (VII), the two carboxyl groups are arranged in such a way that they can form an intramolecular anhydride.

Preferred compounds of the formula (VII) are maleic acid and fumaric acid, especially maleic acid.

Examples of monoethylenically unsaturated C₄-C₂₀ dicarboxylic acids are additionally monoethylenically unsaturated dicarboxylic acids having a cycloaliphatic radical, where both carboxyl groups are bonded to ring carbon atoms of the cycloaliphatic radical. The two carboxyl groups are preferably arranged in such a way that they can form an intramolecular anhydride. The cycloaliphatic radical has a total of 5 to 22 carbon atoms. The cycloaliphatic radical is preferably a monocyclic or bicyclic radical. The cycloaliphatic radical may be substituted by further aliphatic groups, especially alkyl groups, more preferably 1, 2 or 3 C₁-C₄-alkyl groups. More particularly, the cycloaliphatic radical is C₅-C₁₂-cycloalkenyl which is unsubstituted or bears 1, 2 or 3 C₁-C₄-alkyl groups. The cycloaliphatic radical is more preferably a bicyclo[2.2.1]hept-2-en-yl group or a 2-methylbicyclo[2.2.1]hept-2-en-yl group. Examples of cycloaliphatic, monoethylenically unsaturated dicarboxylic acids are bicyclo[2.2.1]hept-5-ene-2,3-dicarboxylic acid and 5-methylbicyclo[2.2.1]hept-5-ene-2,3-dicarboxylic acid.

Suitable monomers Mb are additionally monoethylenically unsaturated C₄-C₂₀ dicarboxylic anhydrides. Useful dicarboxylic anhydrides are, for example, the anhydrides of the aforementioned monoethylenically unsaturated C₄-C₂₀ dicarboxylic acids in which the carboxyl groups are arranged in such a way that they can form an intramolecular anhydride.

Suitable monoethylenically unsaturated C₄-C₂₀ dicarboxylic anhydrides are preferably those of the formula (VIII)

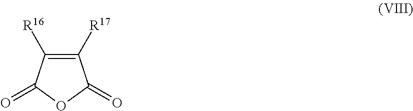

in which
R¹⁶ and R¹⁷ are each independently selected from hydrogen and C₁-C₈-alkyl.

A very particularly preferred compound of the formula (VIII) is maleic anhydride.

Suitable monoethylenically unsaturated C₄-C₂₀ dicarboxylic anhydrides are additionally monoethylenically unsaturated dicarboxylic anhydrides having a cycloaliphatic radical.

The cycloaliphatic radical is generally a monocyclic or bicyclic radical and has a total of 5 to 18 carbon atoms. The cycloaliphatic radical may be substituted by further aliphatic groups, especially alkyl groups, more preferably 1, 2 or 3 C₁-C₄-alkyl groups. Examples of monoethylenically unsaturated dicarboxylic anhydrides having a cycloaliphatic group are bicyclo[2.2.1]hept-5-ene-2,3-dicarboxylic anhydride and 5-methylbicyclo[2.2.1]hept-5-ene-2,3-dicarboxylic anhydride.

Suitable monomers Mb are additionally the monoesters of monoethylenically unsaturated C₄-C₂₀ dicarboxylic acids with compounds of the formula (II). The monoesters of monoethylenically unsaturated C₄-C₂₀ dicarboxylic acids with compounds of the formula (II) are preferably of linear or branched, aliphatic or cycloaliphatic structure. Especially preferred are the C₁-C₁₀-alkyl esters of monoethylenically unsaturated, linear or branched aliphatic C₄-C₁₀ dicarboxylic acids, for example of maleic acid, such as monomethyl maleate.

Suitable monomers Mb are additionally the diesters of monoethylenically unsaturated, linear or branched aliphatic C₄-C₂₀ dicarboxylic acids with compounds of the formula (II). The parent dicarboxylic acid of the diesters is preferably of linear or branched aliphatic or cycloaliphatic structure. With regard to suitable dicarboxylic acids, reference is made to the statements above. Preference is given to the diesters of monoethylenically unsaturated C₄-C₂₀ dicarboxylic acids with compounds of the formula (II). Especially preferred are the C₁-C₁₀-dialkyl esters of monoethylenically unsaturated, linear or branched aliphatic C₄-C₁₀ dicarboxylic acids, for example of maleic acid, such as dimethyl maleate.

Suitable monomers Mb are additionally vinyl esters of linear or branched aliphatic C₁-C₁₀ monocarboxylic acids. Preferred vinyl esters are vinyl acetate, vinyl propionate, vinyl butyrate and vinyl 2-ethylhexanoate.

Suitable monomers Mb are additionally allyl esters of linear or branched aliphatic C₁-C₁₀ monocarboxylic acids. Examples of suitable allyl esters are allyl acetate, allyl propionate, allyl n-butyrate and allyl hexanoate.

Suitable monomers Mb are additionally monoethylenically unsaturated oxiranes of the formula (III)

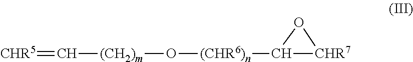

in which
R⁵, R⁶, R⁷ are each independently selected from hydrogen and C₁-C₆-alkyl;
m is an integer from 0 to 20; and
n is an integer from 0 to 10.

Suitable monomers Mb are additionally monoethylenically unsaturated oxiranes of the formula (IV)

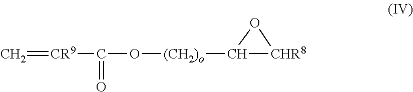

in which
R⁸ and R⁹ are each independently selected from hydrogen and C₁-C₆-alkyl; and
o is an integer from 0 to 5.

Preferred compounds of the formula (IV) are epoxy-containing esters of acrylic acid and/or methacrylic acid, such as glycidyl acrylate and glycidyl methacrylate.

Preferred monomers Mb are especially monoethylenically unsaturated C₃-C₆ monocarboxylic acids, esters of monoethylenically unsaturated C₃-C₆ monocarboxylic acids with C₁-C₁₀-alkanols, monoethylenically unsaturated C₄-C₁₀ dicarboxylic anhydrides, compounds of the formula (IV) and mixtures thereof.

More preferably, the monomer Mb is selected from acrylic acid, methacrylic acid, C₁-C₁₀-alkyl acrylates, C₁-C₁₀-alkyl methacrylates, maleic anhydride, bicyclo[2.2.1]hept-5-en-2,3-dicarboxylic anhydride which is unsubstituted or bears 1, 2 or 3 C₁-C₄-alkyl groups, and mixtures thereof. Specifically, the monomer Mb is selected from acrylic acid, methacrylic acid, ethyl acrylate, n-butyl acrylate, isobutyl acrylate, tert-butyl acrylate, maleic acid, maleic anhydride and bicyclo[2.2.1]hept-5-en-2,3-dicarboxylic anhydride which is unsubstituted or bears 1, 2 or 3 C₁-C₄-alkyl groups, and mixtures thereof.

The polyolefin copolymer A) preferably has a content of monomer Mb of 1% to 50% by weight, preferably 5% to 45% by weight.

In a further embodiment, the polyolefin copolymers A) used in accordance with the invention, in addition to the aforementioned monomers Ma and Mb, comprise at least one further diene copolymerizable therewith as monomer Mc in copolymerized form. Preferably, the monomer Mc is a diene having 4 to 25 carbon atoms. Suitable monomers Mc are conjugated dienes such as isoprene and butadiene and nonconjugated dienes having 5 to 25 carbon atoms, such as penta-1,4-diene, hexa-1,4-diene, hexa-1,5-diene, 2,5-dimethylhexa-1,5-diene and octa-1,4-diene, cyclic dienes such as cyclopentadiene, cyclohexadienes, cyclooctadienes and dicyclopentadiene, and alkenylnorbornenes such as 5-ethylidene-2-norbornene, 5-butylidene-2-norbornene, 2-methallyl-5-norbornene, 2-isopropenyl-5-norbornene and tricyclodienes such as 3-methyltricyclo[5.2.1.0^{2,6}]-3,8-decadiene and mixtures thereof.

Preferred monomers Mc are selected from isoprene, butadiene, hexa-1,5-diene, 5-ethylidenenorbornene and dicyclopentadiene and mixtures thereof. In one embodiment of the invention, no monomers Mc are incorporated into the copolymer.

The content of monomer Mc in the polyolefin copolymer A) is 0% to 15% by weight.

In a further embodiment, the polyolefin copolymers A) used in accordance with the invention, in addition to the aforementioned monomers Ma and Mb and the optional monomer Mc, comprise at least one monomer Md which is different than the monomers Ma, Mb and, if present, monomer Mc and is copolymerizable therewith. Suitable monomers Md are, for example, unsaturated nitriles such as acrylonitrile or methacrylonitrile. In one embodiment of the invention, no monomers Md are incorporated into the copolymer.

Advantageously, the polyolefin copolymers A) consist of 50% to 98% ethene, 0.1% to 20% by weight of monomers comprising epoxy groups and/or monomers comprising (meth)acrylic acid and/or acid anhydride groups, and the residual amount of (meth)acrylic esters.

Particular preference is given to polyolefin copolymers A) formed from
(a) 50% to 98%, especially 55% to 95%, by weight of ethene,
(b1) 0.1% to 40%, especially 0.3% to 20%, by weight of glycidyl acrylate and/or glycidyl methacrylate, (meth)acrylic acid and/or maleic anhydride and
(b2) 1% to 45%, especially 5% to 40%, by weight of n-butyl acrylate and/or 2-ethylhexyl acrylate.

Particular preference is likewise given to polyolefin copolymers A) formed from
(a) 50% to 80%, preferably to 75%, by weight of ethene,
(b1) 2% to 10% by weight of (meth)acrylic acid,
(b2) 0.1% to 2% by weight of maleic acid or maleic anhydride,
(b3) 15% to 40% by weight of n-butyl (meth)acrylate.

The polyolefin copolymers A) used in accordance with the invention are prepared by processes known per se, as described, for example, in WO2005/121249, WO2007/135038, WO2011/051123 or U.S. Pat. No. 5,436,294.

Suitable polyolefin copolymers A) are styrene-ethene-butene block copolymers functionalized with anhydride groups, such as Kraton® G 1901 FX from Kraton.

Suitable polyolefin copolymers A) are additionally styrene-acrylonitrile-maleic anhydride polymers.

Particularly suitable polyolefin copolymers A) are copolymers of ethylene with ethyl or butyl acrylate and acrylic acid and/or maleic anhydride.

Commercial products used with preference are Lupolen® KR 1270 from BASF SE or the Fusabond® product series from DuPont, for example Fusabond® A EB 560D or Fusabond® N MN 598.

Advantageously, the polyolefin copolymers A) are impact modifiers which increase the toughness of the polymer composition.

The content of polyolefin copolymer A) in the polymer composition is generally 0.1% to 30% by weight, based on the total weight of the polymer composition. For example, the content of polyolefin copolymer A) in the polymer composition is 1% to 25% by weight, or 2% to 20% by weight or 2% to 15% by weight, based on the total weight of the polymer composition.

### Component B

As component B), the polymer compositions comprise at least one thermoplastic polyamide B).

Polyamides for use in accordance with the invention can be prepared by various processes and can be synthesized from very different monomer units. Also suitable are blends having fractions of other polymers, for example of polyethylene, polypropylene or ABS (acrylonitrile-butadiene-styrene copolymer).

The reactants for preparation of the polyamides B) used in accordance with the invention are preferably selected from
(a) unsubstituted or substituted aromatic dicarboxylic acids and derivatives of unsubstituted or substituted aromatic dicarboxylic acids,
(b) unsubstituted or substituted aromatic diamines,
(c) aliphatic or cycloaliphatic dicarboxylic acids,
(d) aliphatic or cycloaliphatic diamines,
(e) monocarboxylic acids,
(f) monoamines,
(g) at least trifunctional amines,
(h) lactams,
(I) ω-amino acids,
(k) compounds which are different than (a) to (I) and are cocondensable therewith.

Suitable polyamides B) are aliphatic polyamides. For aliphatic polyamides of the PA Z1Z2 type (such as PA 66), the proviso applies that at least one of components (c) and (d) must be present and neither of components a) and b) may be present. For aliphatic polyamides of the PA Z type (such as PA 6 or PA 12), the proviso applies that at least component h) must be present.

Suitable polyamides B) are additionally semiaromatic polyamides. For semiaromatic polyamides, the proviso applies that at least one of components a) and b) and at least one of components (c) and (d) must be present.

The aromatic dicarboxylic acids (a) are preferably selected from in each case unsubstituted or substituted phthalic acid, terephthalic acid, isophthalic acid, naphthalenedicarboxylic acids or diphenyldicarboxylic acids, and the derivatives and mixtures of the aforementioned aromatic dicarboxylic acids.

Substituted aromatic dicarboxylic acids (a) preferably have at least one (e.g. 1, 2, 3 or 4) C₁-C₄-alkyl radical. More particularly, substituted aromatic dicarboxylic acids (a) have 1 or 2 C₁-C₄-alkyl radicals. These are preferably selected from methyl, ethyl, n-propyl, isopropyl, n-butyl, isobutyl, sec-butyl and tert-butyl, more preferably methyl, ethyl and n-butyl, particularly methyl and ethyl and especially methyl. Substituted aromatic dicarboxylic acids (a) may also bear further functional groups which do not disrupt the amidation, for example 5-sulfoisophthalic acid, and salts and derivatives thereof. A preferred example thereof is the sodium salt of dimethyl 5-sulfoisophthalate.

Preferably, the aromatic dicarboxylic acid (a) is selected from unsubstituted terephthalic acid, unsubstituted isophthalic acid, unsubstituted naphthalenedicarboxylic acids, 2-chloroterephthalic acid, 2-methylterephthalic acid, 5-methylisophthalic acid and 5-sodium isophthalic acid.

More preferably, the aromatic dicarboxylic acid (a) is terephthalic acid, isophthalic acid or a mixture of terephthalic acid and isophthalic acid.

The aromatic diamines (b) are preferably selected from bis(4-aminophenyl)methane, 3-methylbenzidine, 2,2-bis(4-aminophenyl)propane, 1,1-bis(4-aminophenyl)cyclohexane, 1,2-diaminobenzene, 1,4-diaminobenzene, 1,4-diaminonaphthalene, 1,5-diaminonaphthalene, 1,3-diaminotoluene(s), m-xylylenediamine, N,N′-dimethyl-4,4′-biphenyldiamine, bis(4-methylaminophenyl)methane, 2,2-bis(4-methylaminophenyl)propane or mixtures thereof.

The aliphatic or cycloaliphatic dicarboxylic acids (c) are preferably selected from oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, maleic acid, fumaric acid or itaconic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid and mixtures thereof.

The aliphatic or cycloaliphatic diamines (d) are preferably selected from ethylenediamine, propylenediamine, tetramethylenediamine, heptamethylenediamine, hexamethylenediamine, pentamethylenediamine, octamethylenediamine, nonamethylenediamine, 2-methyl-1,8-octamethylenediamine, decamethylenediamine, undecamethylenediamine, dodecamethylenediamine, 2-methylpentamethylenediamine, 2,2,4-trimethylhexamethylenediamine, 2,4,4-trimethylhexamethylenediamine, 5-methylnonamethylenediamine, 2,4-dimethyloctamethylenediamine, 5-methylnonanediamine, bis(4-aminocyclohexyl)methane, 3,3′-dimethyl-4,4′-diaminodicyclohexylmethane, isophoronediamine (IPDA) and mixtures thereof.

More preferably, the diamine (d) is selected from hexamethylenediamine, 2-methylpentamethylenediamine, octamethylenediamine, nonamethylenediamine, decamethylenediamine, undecamethylenediamine, dodecamethylenediamine, bis(4-aminocyclohexyl)methane, 3,3′-dimethyl-4,4′-diaminodicyclohexylmethane, isophoronediamine (IPDA) and mixtures thereof.

In a specific execution, the semiaromatic polyamides B) comprise at least one copolymerized diamine (d) selected from hexamethylenediamine, bis(4-aminocyclohexyl)methane (PACM), 3,3′-dimethyl-4,4′-diaminodicyclohexylmethane (MACM), isophoronediamine (IPDA) and mixtures thereof.

In a specific execution, the semiaromatic polyamides B) comprise exclusively hexamethylenediamine as the copolymerized diamine (d).

In a further specific execution, the semiaromatic polyamides B) comprise exclusively bis(4-aminocyclohexyl)methane as the copolymerized diamine (d).

In a further specific execution, the semiaromatic polyamides B) comprise exclusively 3,3′-dimethyl-4,4′-diaminodicyclohexylmethane (MACM) as the copolymerized diamine (d).

In a further specific execution, the semiaromatic polyamides B) comprise exclusively isophoronediamine (IPDA) as the copolymerized diamine (d).

The aliphatic and the semiaromatic polyamides may comprise at least one copolymerized monocarboxylic acid (e). The monocarboxylic acids (e) serve to end-cap the polyamides B) used in accordance with the invention. Suitable monocarboxylic acids are in principle all of those capable of reacting with at least some of the amino groups available under the reaction conditions of the polyamide condensation. Suitable monocarboxylic acids (e) are aliphatic monocarboxylic acids, alicyclic monocarboxylic acids and aromatic monocarboxylic acids. These include acetic acid, propionic acid, n-, iso- or tert-butyric acid, valeric acid, trimethylacetic acid, caproic acid, enanthic acid, caprylic acid, pelargonic acid, capric acid, undecanoic acid, lauric acid, tridecanoic acid, myristic acid, palmitic acid, stearic acid, pivalic acid, cyclohexanecarboxylic acid, benzoic acid, methylbenzoic acids, α-naphthalenecarboxylic acid, β-naphthalenecarboxylic acid, phenylacetic acid, oleic acid, ricinoleic acid, linoleic acid, linolenic acid, erucic acid, fatty acids from soya, linseeds, castor oil plants and sunflowers, acrylic acid, methacrylic acid, Versatic® acids, Koch® acids and mixtures thereof.

If the monocarboxylic acids (e) used are unsaturated carboxylic acids or derivatives thereof, it may be advisable to work in the presence of commercial polymerization inhibitors.

More preferably, the monocarboxylic acid (e) is selected from acetic acid, propionic acid, benzoic acid and mixtures thereof.

In a specific execution, the aliphatic and the semiaromatic polyamides B) comprise exclusively propionic acid as the copolymerized monocarboxylic acid e).

In a further specific execution, the aliphatic and the semiaromatic polyamides comprise exclusively benzoic acid as the copolymerized monocarboxylic acid (e).

In a further specific execution, the aliphatic and the semiaromatic polyamides B) comprise exclusively acetic acid as the copolymerized monocarboxylic acid (e).

The aliphatic and the semiaromatic polyamides B) may comprise at least one copolymerized monoamine (f). In this case, the aliphatic polyamides B) comprise only copolymerized aliphatic monoamines or alicyclic monoamines. The monoamines (f) serve to end-cap the polyamides used in accordance with the invention. Suitable monoamines are in principle all of those capable of reacting with at least some of the carboxylic acid groups available under the reaction conditions of the polyamide condensation. Suitable monoamines (f) are aliphatic monoamines, alicyclic monoamines and aromatic monoamines. These include methylamine, ethylamine, propylamine, butylamine, pentylamine, hexylamine, heptylamine, octylamine, decylamine, stearylamine, dimethylamine, diethylamine, dipropylamine, dibutylamine, cyclohexylamine, dicyclohexylamine, aniline, toluidine, diphenylamine, naphthylamine and mixtures thereof.

For preparation of the aliphatic and the semiaromatic polyamides B), it is additionally possible to use at least one at least trifunctional amine (g). These include N′-(6-aminohexyl)hexane-1,6-diamine, N′-(12-aminododecyl)dodecane-1,12-diamine, N′-(6-aminohexyl)dodecane-1,12-diamine, N′-[3-(aminomethyl)-3,5,5-trimethylcyclohexyl]hexane-1,6-diamine, N′-[3-(aminomethyl)-3,5,5-trimethylcyclohexyl]dodecane-1,12-diamine, N′-[(5-amino-1,3,3-trimethylcyclohexyl)methyl]hexane-1,6-diamine, N′-[(5-amino-1,3,3-trimethylcyclohexyl)methyl]dodecane-1,12-diamine, 3-[[[3-(aminomethyl)-3,5,5-trimethylcyclohexyl]amino]methyl]-3,5,5-trimethylcyclohexanamine, 3-[[(5-amino-1,3,3-trimethylcyclohexyl)methylamino]methyl]-3,5,5-trimethylcyclohexanamine, 3-(aminomethyl)-N-[3-(aminomethyl)-3,5,5-trimethylcyclohexyl]-3,5,5-trimethylcyclohexanamine. Preferably, no at least trifunctional amines (g) are used.

Suitable lactams (h) are ε-caprolactam, 2-piperidone (δ-valerolactam), 2-pyrrolidone (γ-butyrolactam), capryllactam, enantholactam, lauryllactam and mixtures thereof.

Suitable ω-amino acids (I) are 6-aminocaproic acid, 7-aminoheptanoic acid, 11-aminoundecanoic acid, 12-aminododecanoic acid and mixtures thereof.

Suitable compounds (k) which are different than (a) to (I) and are cocondensable therewith are at least tribasic carboxylic acids, diaminocarboxylic acids, etc.

Suitable compounds (k) are additionally 4-[(Z)—N-(6-aminohexyl)-C-hydroxycarbonimidoyl]benzoic acid, 3-[(Z)—N-(6-aminohexyl)-C-hydroxycarbonimidoyl]benzoic acid, (6Z)-6-(6-aminohexylimino)-6-hydroxyhexanecarboxylic acid, 4-[(Z)—N-[(5-amino-1,3,3-trimethylcyclohexyl)methyl]-C-hydroxycarbonimidoyl]benzoic acid, 3-[(Z)—N-[(5-amino-1,3,3-trimethylcyclohexyl)methyl]-C-hydroxycarbonimidoyl]benzoic acid, 4-[(Z)—N-[3-(aminomethyl)-3,5,5-trimethylcyclohexyl]-C-hydroxycarbonimidoyl]benzoic acid, 3-[(Z)—N-[3-(aminomethyl)-3,5,5-trimethylcyclohexyl]-C-hydroxycarbonimidoyl]benzoic acid and mixtures thereof.

In a preferred embodiment, the polyamide B) used in accordance with the invention is an aliphatic polyamide.

In that case, the polyamide B) is preferably selected from PA 6, PA 11, PA 12, PA 46, PA 66, PA 6/66, PA 69, PA 610, PA 612, PA 96, PA 99, PA 910, PA 912, PA 1212, and copolymers and mixtures thereof.

More particularly, the aliphatic polyamide B) is PA 6, PA 66, PA 610 or PA 6/66, most preferably PA 6, PA 66 and PA 610.

In a further preferred embodiment, the polyamide B) used in accordance with the invention is a semiaromatic polyamide.

The polyamide B) is preferably selected from PA 6.T, PA 9.T, PA8.T, PA 10.T, PA 12.T, PA 6.I, PA 8.I, PA 9.I, PA 10.I, PA 12.I, PA 6.T/6, PA 6.T/10, PA 6.T/12,

### PA 6.T/6.I, PA6.T/8.T, PA 6.T/9.T, PA 6.T/10T, PA 6.T/12.T, PA 12.T/6.T, PA 6.T/6.I/6,

### PA 6.T/6.I/12, PA 6.T/6.I/6.10, PA 6.T/6.I/6.12, PA 6.T/6.6, PA 6.T/6.10, PA 6.T/6.12,

### PA 10.T/6, PA 10.T/11, PA 10.T/12, PA 8.T/6.T, PA 8.T/66, PA 8.T/8.I, PA 8.T/8.6,

### PA 8.T/6.I, PA 10.T/6.T, PA 10.T/6.6, PA 10.T/10.I, PA 10T/10.1/6.T, PA 10.T/6.I,

### PA 4.T/4.1/46, PA 4.T/4.I/6.6, PA 5.T/5.I, PA 5.T/5.I/5.6, PA 5.T/5.I/6.6, PA 6.T/6.I/6.6,

### PA MXDA.6, PA IPDA.I, PA IPDA.T, PA MACM.I, PA MACM.T, PA PACM.I,

### PA PACM.T, PA MXDA.I, PA MXDA.T, PA 6.T/IPDA.T, PA 6.T/MACM.T,

### PA 6.T/PACM.T, PA 6.T/MXDA.T, PA 6.T/6.I/8.T/8.I, PA 6.T/6.I/10.T/10.1,

### PA 6.T/6.I/IPDA.T/IPDA.I, PA 6.T/6.I/MXDA.T/MXDA.1, PA 6.T/6.I/MACM.T/MACM.I,

### PA 6.T/6.I/PACM.T/PACM.I, PA 6.T/10.T/IPDA.T, PA 6.T/12.T/IPDA.T,

PA 6.T/10.T/PACM.T, PA 6.T/12.T/PACM.T, PA 10.T/IPDA.T, PA 12.T/IPDA.T and copolymers and mixtures thereof.

In that case, the polyamide B) is more preferably selected from PA 6.T, PA 9.T, PA 10.T, PA 12.T, PA 6.I, PA 9.I, PA 10.I, PA 12.I, PA 6.T/6.I, PA 6.T/6, PA6.T/8.T, PA 6.T/10T, PA 10.T/6.T, PA 6.T/12.T, PA12.T/6.T, PA IPDA.I, PA IPDA.T, PA 6.T/IPDA.T, PA 6.T/6.I/IPDA.T/IPDA.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T, and copolymers and mixtures thereof.

The polyamide B) is most preferably selected from PA 6, PA 66, PA610 and PA 6.T/6.I.

The content of polyamide B) in the polymer composition is generally 10% to 99.9% by weight, based on the total weight of the polymer composition. Preferably, the polymer composition comprises 20% to 70% by weight, especially 25% to 65% by weight, of polyamide B).

The polymer composition may comprise, as well as the polyolefin component A) and the polyamide B), a fibrous or particulate filler as component C).

In the context of the invention, the term “filler” is to be interpreted broadly and comprises particulate fillers, fibrous substances and any intermediate forms. Particulate fillers may have a wide range of particle sizes ranging from beads in the form of dusts to large grains. Useful filler materials include organic or inorganic fillers and reinforcers. For example, it is possible to use inorganic fillers, such as kaolin, chalk, wollastonite, talc, calcium carbonate, silicates, titanium dioxide, zinc oxide, glass particles, e.g. glass beads, nanoscale sheet silicates, nanoscale alumina (Al₂O₃), nanoscale titania (TiO₂), permanently magnetic or magnetizable metal compounds and/or alloys, sheet silicates and nanoscale silica (SiO₂). The fillers may also have been surface treated.

Examples of sheet silicates used in the polymer compositions include kaolins, serpentines, talc, mica, vermiculites, illites, smectites, montmorillonite, hectorite, double hydroxides or mixtures thereof. The sheet silicates may have been surface treated or may be untreated.

In addition, it is possible to use one or more fibrous substances. These are preferably selected from known inorganic reinforcing fibers, such as boron fibers, glass fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

It is especially preferable to use glass fibers, aramid fibers, boron fibers, metal fibers or potassium titanate fibers.

Specifically, chopped glass fibers are used. More particularly, component C) comprises glass fibers, preference being given to using short fibers. These preferably have a length in the range from 2 to 50 mm and a diameter of 5 to 40 μm. Alternatively, it is possible to use continuous fibers (rovings). Suitable fibers are those having a circular and/or noncircular cross-sectional area, in which latter case the ratio of dimensions of the main cross-sectional axis to the secondary cross-sectional axis is especially >2, preferably in the range from 2 to 8 and more preferably in the range from 3 to 5.

In a specific execution, component C) comprises what are called “flat glass fibers”. These specifically have a cross-sectional area which is oval or elliptical or elliptical and provided with indentation(s) (called “cocoon” fibers), or rectangular or virtually rectangular. Preference is given here to using glass fibers with a noncircular cross-sectional area and a ratio of dimensions of the main cross-sectional axis to the secondary cross-sectional axis of more than 2, preferably of 2 to 8, especially of 3 to 5.

For reinforcement of the polymer compositions, it is also possible to use mixtures of glass fibers having circular and noncircular cross sections. In a specific execution, the proportion of flat glass fibers, as defined above, predominates, meaning that they account for more than 50% by weight of the total mass of the fibers.

If rovings of glass fibers are used as component C), these preferably have a diameter of 10 to 20 μm, preferably of 12 to 18 μm. In this case, the cross section of the glass fibers may be round, oval, elliptical, virtually rectangular or rectangular. Particular preference is given to what are called flat glass fibers having a ratio of the cross-sectional axes of 2 to 5. More particularly, E glass fibers are used. However, it is also possible to use all other glass fiber types, for example A, C, D, M, S or R glass fibers or any desired mixtures thereof, or mixtures with E glass fibers.

In the case of use of component C) in the polymer composition, the polymer composition may comprise 1% to 75% by weight, based on the total weight of the polymer composition, of component C). Preferably, component C) is used in an amount of 5% to 50% by weight, especially 10% to 40% by weight, based on the total weight of the polymer composition.

The polymer composition may comprise additives in a proportion of 0% to 50%, preferably 0.1% to 45% and more preferably 0.2% to 30% by weight, based on the total weight of the polymer composition, as component D). Preferably, component D) is selected from heat stabilizers, flame retardants, light stabilizers, lubricants, dyes, nucleating agents, pigments, metal flakes, metal-coated particles, antistats, conductivity additives, demolding agents, optical brighteners and defoamers.

Suitable light stabilizers (UV stabilizers, UV absorbers or UV blockers), which are generally used in amounts of 0% to 2% by weight, based on the total weight of the polymer composition, are substituted resorcinols, salicylates, benzotriazoles and benzophenones, and also sterically hindered P-containing compounds, sterically hindered amines and carbodiimines.

The heat stabilizer is preferably used in amounts of 0.01% to 3% by weight, more preferably 0.02% to 2% by weight, especially 0.1% to 1.5% by weight, based on the total weight of the polymer composition. Suitable heat stabilizers are copper compounds, secondary aromatic amines, sterically hindered phenols, phosphites, phosphonites and mixtures thereof.

If a copper compound is used, the amount of copper is preferably 0.003% to 0.5%, especially 0.005% to 0.3% and more preferably 0.01% to 0.2% by weight, based on the total weight of the polymer composition.

If stabilizers based on secondary aromatic amines are used, the amount of these stabilizers is preferably 0.2% to 2% by weight, more preferably from 0.2% to 1.5% by weight, based on the total weight of the polymer composition.

If stabilizers based on sterically hindered phenols are used, the amount of these stabilizers is preferably 0.1% to 1.5% by weight, more preferably from 0.2% to 1% by weight, based on the total weight of the polymer composition.

If stabilizers based on phosphites and/or phosphonites are used, the amount of these stabilizers is preferably 0.1% to 1.5% by weight, more preferably from 0.2% to 1% by weight, based on the total weight of the polymer composition.

Suitable copper compounds are compounds of mono- or divalent copper, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, CuI, CuCN and Cu₂O, and to the divalent copper compounds CuCl₂, CuSO4, CuO, copper(II) acetate or copper(II) stearate.

The copper compounds are commercially available, or the preparation thereof is known to those skilled in the art. The copper compound can be used as such or in the form of concentrates. A concentrate is understood to mean a polymer, preferably of the same chemical nature as component A), comprising a high concentration of the copper salt. The use of concentrates is a standard method and is employed particularly frequently when metering of very small amounts of a feedstock is necessary. Advantageously, the copper compounds are used in combination with further metal halides, especially alkali metal halides, such as Nal, KI, NaBr, KBr, in which case the molar ratio of metal halide to copper halide is 0.5 to 20, preferably 1 to 10 and more preferably 3 to 7.

Particularly preferred examples of stabilizers which are based on secondary aromatic amines and are usable in accordance with the invention are adducts of phenylenediamine with acetone (Naugard® A), adducts of phenylenediamine with linolene, Naugard® 445, N,N′-dinaphthyl-p-phenylenediamine, N-phenyl-N′-cyclohexyl-p-phenylenediamine or mixtures of two or more thereof.

Preferred examples of stabilizers which are based on sterically hindered phenols and are usable in accordance with the invention are N,N′-hexamethylenebis-3-(3,5-di-tert-butyl-4-hydroxyphenyl)propionamide, bis(3,3-bis(4′-hydroxy-3′-tert-butylphenyl)butanoic acid) glycol ester, 2,1′-thioethyl bis(3-(3,5-di-tert-butyl-4-hydroxyphenyl)propionate, 4,4′-butylidenebis(3-methyl-6-tert-butylphenol), triethylene glycol 3-(3-tert-butyl-4-hydroxy-5-methylphenyl)propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methylphenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo-[d,g]-1,3,2-dioxaphosphocin, 6-fluoro-2,4,8,10-tetra-tert-butyl-12-methyldibenzo[d,g]-1,3,2-dioxaphosphocin, bis(2,4-di-tert-butyl-6-methylphenyl)methyl phosphite and bis(2,4-di-tert-butyl-6-methylphenyl) ethyl phosphite. More particularly, preference is given to tris[2-tert-butyl-4-thio(2′-methyl-4′-hydroxy-5′-tert-butyl)phenyl-5-methyl]phenyl phosphite and tris(2,4-di-tert-butylphenyl)phosphite (Hostanox® PAR24: commercial product from BASF SE).

One preferred embodiment of the thermal stabilizer consists in the combination of organic heat stabilizers (particularly Hostanox® PAR 24 and Irganox® 1010), a bisphenol A-based epoxide (particularly Epikote® 1001) and a copper stabilizer based on CuI and KI. An example of a commercially available stabilizer mixture consisting of organic stabilizers and epoxides is Irgatec® NC66 from BASF SE. More particularly, preference is given to heat stabilization exclusively based on CuI and KI. Aside from the addition of copper or copper compounds, the use of further transition metal compounds, especially metal salts or metal oxides of group VB, VIB, VIIB or VIIIB of the Periodic Table, is ruled out. In addition, it is preferable not to add any transition metals of group VB, VIB, VIIB or VIIIB of the Periodic Table, for example iron powder or steel powder, to the polymer composition.

As component D), the polymer composition preferably comprises 0% to 30% by weight, more preferably 0% to 20% by weight, based on the total weight of the polymer composition, of at least one flame retardant. When the polymer composition comprises at least one flame retardant, it preferably does so in an amount of 0.01% to 30% by weight, more preferably of 0.1% to 20% by weight, based on the total weight of the polymer composition. Useful flame retardants D) include halogenated and halogen-free flame retardants and synergists thereof (see also Gächter/Müller, 3rd edition 1989 Hanser Verlag, chapter 11). Preferred halogen-free flame retardants are red phosphorus, phosphinic or diphosphinic salts and/or nitrogen-containing flame retardants such as melamine, melamine cyanurate, melamine sulfate, melamine borate, melamine oxalate, melamine phosphate (primary, secondary) or secondary melamine pyrophosphate, neopentyl glycol boric acid melamine, guanidine and derivatives thereof known to those skilled in the art, and also polymeric melamine phosphate (CAS No.: 56386-64-2 or 218768-84-4, and also EP 1095030), ammonium polyphosphate, trishydroxyethyl isocyanurate (optionally also ammonium polyphosphate in a mixture with trishydroxyethyl isocyanurate) (EP584567). Further N-containing or P-containing flame retardants, or PN condensates suitable as flame retardants, can be found in DE 10 2004 049 342, as can the synergists customary for this purpose, such as oxides or borates. Suitable halogenated flame retardants are, for example, oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, Dechlorane, which are usually used with antimony oxides as synergists (for details and further flame retardants see DE-A-10 2004 050 025).

Pigments used may be inorganic pigments such as titanium dioxide, ultramarine blue, iron oxide, ZnO and boehmite, AlO(OH), and organic pigments such as phthalocyanines, quinacridones or perylenes.

Dyes are all the dyes which can be used for transparent, semitransparent, or nontransparent coloring, especially those suitable for coloring of polyamides. Among these, preference is given to those suitable for transparent or semitransparent coloring. Dyes of this kind are known to those skilled in the art.

Nucleating agents used may be sodium phenylphosphinate, alumina, silica, and preferably talc.

Lubricants or demolding agents used may be the aluminum, alkali metal or alkaline earth metal salts or esters or amides of fatty acids having 10 to 44 carbon atoms, preferably having 12 to 44 carbon atoms, in an amount of 0% to 3% by weight, preferably 0.05% to 3% by weight, especially 0.1% to 1.5% by weight and most preferably 0.1% to 1% by weight, based on the total weight of the polymer composition. Preference is given to using the alkaline earth metal and aluminum salts, particular preference being given to calcium, magnesium and aluminum.

It is also possible to use mixtures of various salts, in which case the mixing ratio is as desired.

The carboxylic acids may be monobasic or dibasic. Examples include pelargonic acid, palmitic acid, lauric acid, margaric acid, dodecanedioic acid, behenic acid, and more preferably stearic acid, capric acid and montanic acid (a mixture of fatty acids having 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono- to trifunctional. Examples of these are stearylamine, ethylenediamine, propylenediamine, hexamethylenediamine, di(6-aminohexyl)amine, preference being given to ethylenediamine and hexamethylenediamine. Preferred esters or amides are correspondingly glyceryl distearate, glyceryl tristearate, ethylenediamine distearate, glyceryl monopalmitate, glyceryl trilaurate, glyceryl monobehenate and pentaerythrityl tetrastearate. It is also possible to use mixtures of various esters or amides or esters combined with amides, in which case the mixing ratio is as desired.

Very particular preference is given to lubricant calcium stearate, calcium montanate or aluminum stearate.

It is particularly advantageous to use polyolefin copolymers A) in accordance with the invention in polymer compositions comprising at least one thermoplastic polyamide B) for production of films, monofilaments, fibers, yarns or textile fabrics.

It is likewise particularly advantageous to use polyolefin copolymers A) in accordance with the invention in polymer compositions comprising at least one thermoplastic polyamide B), in which case the polymer composition is used in electrical and electronic components or for high-temperature automotive applications.

Polymer compositions in which the polyamide B) is a semiaromatic polyamide are advantageously suitable for production of moldings for electrical and electronic components and for high-temperature automotive applications.

In the automotive sector, use is possible in the automobile interior and in the automobile exterior, for example for cylinder head covers, engine hoods, housings for charge air coolers, charge air cooler valves, intake pipes, intake manifolds, connectors, gears, fan impellers, cooling water tanks, housings or housing parts for heat exchangers, coolant coolers, charge air coolers, thermostats, water pumps, heating elements, securing parts, dashboards, steering column switches, seat components, headrests, center consoles, gearbox components, door modules, door handles, exterior mirror components, grilles, roof rails, sunroof frames, windshield wipers and exterior bodywork parts.

It is likewise particularly advantageous to use polyolefin copolymers A) in accordance with the invention in polymer compositions comprising at least one thermoplastic polyamide B), in which case the polymer compositions find use in the form of moldings as or as part of an electrical or electronic passive or active component, of a printed circuit board, of part of a printed circuit board, of a housing constituent, of a film, or of a wire, more particularly in the form of or as part of a switch, of a plug, of a bushing, of a distributor, of a relay, of a resistor, of a capacitor, of a winding or of a winding body, of a lamp, of a diode, of an LED, of a transistor, of a connector, of a regulator, of an integrated circuit (IC), of a processor, of a controller, of a memory element and/or of a sensor.

The polymer compositions comprising a semiaromatic polyamide as component B) are additionally specifically suitable for use in soldering operations under lead-free conditions (lead free soldering), for production of plug connectors, microswitches, microbuttons and semiconductor components, especially reflector housings of light-emitting diodes (LEDs).

A specific embodiment is use as a securing element for electrical or electronic components, such as spacers, bolts, fillets, push-in guides, screws and nuts.

Especially preferred is use in the form of or as part of a socket, of a plug connector, of a plug or of a bushing, which require mechanical toughness. Examples of such functional elements are film hinges, snap-in hooks and spring tongues.

Possible uses for the kitchen and household sector are for production of components for kitchen machines, for example fryers, smoothing irons, knobs, and also applications in the garden and leisure sector, for example components for irrigation systems or garden equipment and door handles.

The present invention further provides a method of reducing color changes in polymer compositions, wherein
(i) a polymer composition comprising at least one thermoplastic polyamide B) as defined above is provided; and
(ii) a polyolefin copolymer A) as defined above is incorporated into the polymer composition.

The polymer compositions can be prepared by methods known per se, by mixing the starting components A) and B) and optionally components C) and D) in conventional mixing apparatuses, such as screw extruders, Brabender mixers or Banbury mixers, and then extruding them. After the extrusion, the extrudate can be cooled and comminuted. It is also possible to premix individual components and then to add the remaining starting materials individually and/or likewise in the form of a mixture. The mixing temperatures are generally 230 to 320° C.

Preference is given to a method of reducing color changes in polyamide-containing polymer compositions in the course of heating, wherein
(i) at least one polyolefin copolymer A) as defined above and at least one thermoplastic polyamide B) are provided;
(ii) the polymer components provided in (i) are mixed and heated to obtain a polymer composition, giving a moldable molten polymer composition; and
(iii) the molten polymer composition obtained in (ii) is subjected to a molding operation,
   with the proviso that the polymer composition is heated in step (ii) to a temperature at least 10° C. above the highest glass transition temperature of the polymer component present in the polymer composition or, if at least one polymer component has a melting point, at least 10° C. above the melting temperature of the highest-melting polymer component.

The mixing and melting can be effected in any suitable apparatus, such as an extruder having a kneader profile or a Banbury mixer.

In the shaping in step (iii), the polymer composition can be formed thermally, for example by means of injection molding, extrusion, thermoforming or blow molding. Preferably, the polymer composition in step (ii) is first formed to give one or more strands. For this purpose, it is possible to use apparatuses known to those skilled in the art, for example extruders having perforated plates, dies or die plates, for example, on the discharge side. Preferably, the polymer composition is shaped in the free-flowing state to strands and subjected to pelletization in the form of strands of free-flowing reaction product or after cooling.

The invention further provides a method of using at least one polyolefin copolymer A) as described above in a polymer composition comprising at least one thermoplastic polyamide B) as described above for reducing color changes in the course of heating of the polymer composition.

The examples which follow serve to illustrate the invention, but without restricting it in any way.

### Examples

The following components were used:

### Component A/1:

poly(ethylene-co-butyl acrylate-co-maleic anhydride-co-acrylic acid); Lupolen® KR 1270 from BASF SE was used.

### Component A/2:

poly(ethylene-co-butyl acrylate-co-maleic anhydride-co-acrylic acid); Fusabond® NM 598 D from DuPont was used.

### Component A/3:

copolymer of ethylene-butyl acrylate rubber, functionalized with maleic anhydride; Fusabond® A EB 560 D from DuPont was used.

### Component B/1:

polyamide-6,6; Ultramid® A27 from BASF SE was used.

### Component B/2:

polyamide-6,6; Ultramid® A34 from BASF SE was used.

### Component B/3:

polyamide-6; Ultramid® B27 from BASF SE was used.
Component B/4: polyamide-6,10; Ultramid® S3K from BASF SE was used.

### Component B/5:

polyphthalamide

### Component C/1:

glass fibers

### Component D/1:

calcium montanate; Licomat® CaV 102 from Clariant was used.

### Component D/2:

talc

### Component D/3:

heat stabilizer: CuI/KI stabilizer

### Component D/4:

lubricant: Luwax® OA5, BASF SE (oxidized polyethylene wax)

The components specified in table 1 were homogenized in a ZSK25 twin-screw extruder (from Werner & Pfleiderer) and then extruded. The extrudates were pelletized and dried. The pellets were used to produce test specimens on an injection molding machine, and the properties specified in table 1 were determined. The test specimens of examples C-1, 1 and 2 and C-2 and 3 were extruded at a temperature of 295° C. and processed further by injection molding at 290° C. The test specimens of examples C-3 and 4 and C-4 and 5 were extruded at a temperature of 285° C. and processed further by injection molding at 280° C. The test specimens of examples C-5 and 6 and C-6 and 7 were extruded at 340° C. and processed further at 330° C.

Measurement of yellowness index

The yellowness index YI was determined to ASTM D 1925 on injection-molded plaques (10×10 mm; thickness: 2 mm).

Determination of color properties by CIE-L*a*b*

The CIE L*a*b* data were determined (DIN 6174) with a colorimeter having an Ulbricht sphere, standard illumination, d65, 10° with inclusion of surface reflection.

TABLE 1
Composition and properties of the polymer composition
(leading C: for comparison)

| | Ex. | | | | | | | | | | | | |
|---|---|---|---|---|---|---|---|---|---|---|---|---|---|
| | C-1 | 1 | 2 | C-2 | 3 | C-3 | 4 | C-4 | 5 | C-5 | 6 | C-6 | 7 |
| A/1 | | 6.0 | | | | | 6.0 | | | | | | |
| A/2 | | | 6.0 | | 6.0 | | | | 6.0 | | | | |
| A/3 | | | | | | | | | | | 3.0 | | 4.0 |
| B/1 | 69.75 | 63.75 | | 69.75 | 63.75 | | | | | | | | |
| B/2 | | | 63.75 | | | | | | | | | | |
| B/3 | | | | | | 69.75 | 63.75 | | | | | | |
| B/4 | | | | | | | | 69.75 | 63.75 | | | | |
| B/5 | | | | | | | | | | 63.80 | 60.80 | 64.30 | 60.3 |
| C/1 | 30 | 30 | 30 | 30 | 30 | 30 | 30 | 30 | 30 | 35 | 35 | 35 | 35 |
| D/1 | 0.25 | 0.25 | 0.25 | 0.25 | 0.25 | 0.25 | 0.25 | 0.25 | 0.25 | 0.35 | 0.35 | 0.35 | 0.35 |
| D/2 | | | | | | | | | | 0.05 | 0.05 | 0.05 | 0.05 |
| D/3 | | | | | | | | | | 0.3 | 0.3 | 0.3 | 0.3 |
| D/4 | | | | | | | | | | 0.50 | 0.50 | | |
| L* | 74.8 | 80.7 | 83.1 | 68.7 | 79.7 | 69.6 | 82.0 | 66.3 | 79.9 | 58.3 | 77.0 | 67.8 | 87.0 |
| a* | −0.3 | −0.4 | −1.3 | −2.0 | −1.6 | −3.7 | −3.2 | −4.6 | −4.8 | 3.5 | 0.0 | −2.1 | −1.7 |
| b* | 28.6 | 24.0 | 21.8 | 17.4 | 19.3 | 28.9 | 24.9 | 5.8 | 6.3 | 23.3 | 22.7 | 23.4 | 18.2 |
| YI | 56.8 | 46.6 | 41.1 | 37.8 | 37.8 | 56.8 | 45.0 | 10.1 | 9.6 | 61.1 | 46.2 | 49.6 | 33.6 |

These examples demonstrate the lower intrinsic color of the polyamide-containing polymer compositions additized in accordance with the invention compared to polyamide-containing polymer compositions having noninventive additization. Thus, polyamide-containing polymer compositions having improved optical properties (higher whiteness, lower yellowness index) are obtained.

1. A method for reducing color changes in the course of heating of a polymer composition comprising at least one thermoplastic polyamide B) comprising the use of a polyolefin copolymer A, wherein the polyolefin copolymer A) comprises at least one ethylenically unsaturated monomer Ma and at least one monoethylenically unsaturated monomer Mb in copolymerized form, wherein
monomer Ma is selected from
C₂-C₁₀-alkenes and vinylaromatic compounds of the formula (I) 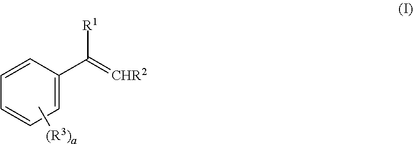
in which
R¹ and R² are each independently selected from hydrogen, C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl;
R³ is C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl; and
a is 0, 1 or 2;
and
monomer Mb is selected from
monoethylenically unsaturated C₃-C₂₃ monocarboxylic acids;
esters of monoethylenically unsaturated C₃-C₂₃ monocarboxylic acids with compounds of formula (II)
R⁴—OH (II),
in which
R⁴ is C₁-C₁₀-alkyl, C₃-C₁₂-cycloalkyl or phenyl, where C₃-C₁₂-cycloalkyl and phenyl are unsubstituted or mono- or polysubstituted by C₁-C₁₀-alkyl;
N—C₁-C₈-alkyl-substituted amides of monoethylenically unsaturated C₃-C₂₃ monocarboxylic acids;
monoethylenically unsaturated C₄-C₂₀ dicarboxylic acids;
monoethylenically unsaturated C₄-C₂₀ dicarboxylic anhydrides;
monoesters of monoethylenically unsaturated C₄-C₂₀ dicarboxylic acids with compounds of formula (II);
diesters of monoethylenically unsaturated C₄-C₂₀ dicarboxylic acids with compounds of formula (II);
vinyl esters of C₁-C₁₀ monocarboxylic acids;
allyl esters of C₁-C₁₀ monocarboxylic acids;
monoethylenically unsaturated oxiranes of the formula (III); and
monoethylenically unsaturated oxiranes of the formula (IV) 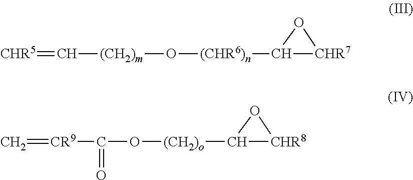
in which
R⁵, R⁶, R⁷, R⁸ and R⁹ are each independently selected from hydrogen and C₁-C₆-alkyl;
m is an integer from 0 to 20;
n is an integer from 0 to 10; and
o is an integer from 0 to 5.

2. The method according to claim 1, wherein the polyolefin copolymer A) additionally comprises at least one diene having 4 to 25 carbon atoms as monomer Mc.

3. The method according to claim 1, wherein the monomer Ma is selected from ethene, propene, 1-butene and mixtures thereof.

4. The method according to claim 1, wherein the monomer Mb is selected from the group consisting of monoethylenically unsaturated C₃-C₆ monocarboxylic acids, esters of monoethylenically unsaturated C₃-C₆ monocarboxylic acids with C₁-C₁₀-alkanols, monoethylenically unsaturated C₄-C₁₀ dicarboxylic anhydrides, compounds of the formula IV, and mixtures thereof.

5. The method according to claim 4, wherein the monomer Mb is selected from acrylic acid, methacrylic acid, C₁-C₁₀-alkyl acrylates, C₁-C₁₀-alkyl methacrylates, maleic anhydride, bicyclo[2.2.1]hept-5-en-2,3-dicarboxylic anhydride which is unsubstituted or bears 1, 2 or 3 C₁-C₄-alkyl groups, and mixtures thereof.

6. The method according to claim 1, in which the monomer Mc is selected from isoprene, butadiene, hexa-1,5-diene, 5-ethylidenenorbornene and dicyclopentadiene.

7. The method according to claim 1, wherein the polyamide B) is selected from PA 6, PA 66, PA610, PA 6.T, PA 9.T, PA8.T, PA 10.T, PA 12.T, PA 6.I, PA 8.I, PA 9.I, PA 10.I, PA 12.I, PA 6.T/6, PA 6.T/10, PA 6.T/12,
PA 6.T/6.I, PA6.T/8.T, PA 6.T/9.T, PA 6.T/10T, PA 6.T/12.T, PA 12.T/6.T,
PA 6.T/6.I/6, PA 6.T/6.I/12, PA 6.T/6.I/6.10, PA 6.T/6.I/6.12, PA 6.T/6.6,
PA 6.T/6.10, PA 6.T/6.12, PA 10.T/6, PA 10.T/11, PA 10.T/12, PA 8.T/6.T,
PA 8.T/66, PA 8.T/8.I, PA 8.T/8.6, PA 8.T/6.I, PA 10.T/6.T, PA 10.T/6.6,
PA 10.T/10.I, PA 10T/10.I/6.T, PA 10.T/6.I, PA 4.T/4.I/46, PA 4.T/4.I/6.6,
PA 5.T/5.I, PA 5.T/5.I/5.6, PA 5.T/5.I/6.6, PA 6.T/6.I/6.6, PA MXDA.6,
PA IPDA.I, PA IPDA.T, PA MACM.I, PA MACM.T, PA PACM.I, PA PACM.T,
PA MXDA.I, PA MXDA.T, PA 6.T/IPDA.T, PA 6.T/MACM.T, PA 6.T/PACM.T,
PA 6.T/MXDA.T, PA 6.T/6.I/8.T/8.I, PA 6.T/6.I/10.T/10.I,
PA 6.T/6.I/IPDA.T/IPDA.I, PA 6.T/6.I/MXDA.T/MXDA.I,
PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T,
PA 10.T/IPDA.T, PA 12.T/IPDA.T and copolymers and mixtures thereof.

8. The method according to claim 1, wherein the polyamide B) is selected from PA 6, PA 66, PA 610, and PA 6.T/6.I and mixtures thereof.

9. The method according to claim 1, wherein the polyolefin copolymer A) is used in an amount of 0.1% to 30% by weight, based on the total weight of the polymer composition.

10. The method according to claim 1, wherein the polymer composition additionally comprises at least one fibrous or particulate filler as component C).

11. The method according to claim 1, wherein the polymer composition comprises at least one further additive as component D), preferably selected from heat stabilizers, flame retardants, light stabilizers, lubricants, dyes, nucleating agents, pigments, metal flakes, metal-coated particles, antistats, conductivity additives, demolding agents, optical brighteners and defoamers.

12. The method according to claim 1, wherein the polymer composition is used for production of films, monofilaments, fibers, yarns or textile fabrics.

13. The method according to claim 1, wherein the polymer composition is used in electrical and electronic components or for high-temperature automotive applications.

14. The method according to claim 13, wherein the polymer composition is used in soldering operations under lead-free conditions (lead free soldering), for production of plug connectors, microswitches, microbuttons and semiconductor components, especially reflector housings of light-emitting diodes (LEDs).

15. A method of reducing color changes in a polymer composition in the course of heating, wherein
(i) at least one polyolefin copolymer A) and at least one thermoplastic polyamide B) are provided;
(ii) the polymer components provided in (i) are mixed and heated to obtain a polymer composition, giving a moldable molten polymer composition; and
(iii) the molten polymer composition obtained in (ii) is subjected to a molding operation,
with the proviso that the polymer composition is heated in step (ii) to a temperature at least 10° C. above the highest glass transition temperature of the polymer component present in the polymer composition or, if at least one polymer component has a melting point, at least 10° C. above the melting temperature of the highest-melting polymer component,
wherein the polyolefin copolymer A) comprises at least one ethylenically unsaturated monomer Ma and at least one monoethylenically unsaturated monomer Mb in copolymerized form, wherein
monomer Ma is selected from
C₂-C₁₀-alkenes and vinylaromatic compounds of the formula (I) 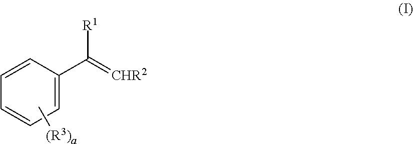
in which
R¹ and R² are each independently selected from hydrogen, C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl;
R³ is C₁-C₁₀-alkyl, C₃-C₁₂-cycloalkyl and phenyl, where C₃-C₁₂-cycloalkyl and phenyl are unsubstituted or mono- or polysubstituted by C₁-C₁₀-alkyl; and
a is 0, 1 or 2;
and
monomer Mb is selected from
monoethylenically unsaturated C₃-C₂₃ monocarboxylic acids;
esters of monoethylenically unsaturated C₃-C₂₃ monocarboxylic acids with compounds of formula (II)
R⁴—OH (II),
in which
R⁴ is C₁-C₁₀-alkyl, C₃-C₁₂-cycloalkyl or phenyl, where C₃-C₁₂-cycloalkyl and phenyl are unsubstituted or mono- or polysubstituted by C₁-C₁₀-alkyl;
N—C₁-C₈-alkyl-substituted amides of monoethylenically unsaturated C₃-C₂₃ monocarboxylic acids;
monoethylenically unsaturated C₄-C₂₀ dicarboxylic acids;
monoethylenically unsaturated C₄-C₂₀ dicarboxylic anhydrides;
monoesters of monoethylenically unsaturated C₄-C₂₀ dicarboxylic acids with compounds of formula (II);
diesters of monoethylenically unsaturated C₄-C₂₀ dicarboxylic acids with compounds of formula (II);
vinyl esters of C₁-C₁₀ monocarboxylic acids;
allyl esters of C₁-C₁₀ monocarboxylic acids;
monoethylenically unsaturated oxiranes of the formula (III); and
monoethylenically unsaturated oxiranes of the formula (IV) 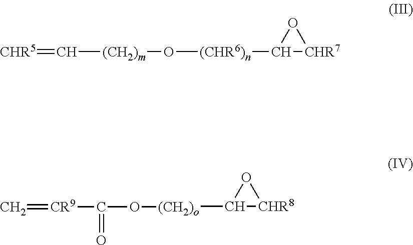
in which
R⁵, R⁶, R⁷, R⁸ and R⁹ are each independently selected from hydrogen and C₁-C₆-alkyl;
m is an integer from 0 to 20;
n is an integer from 0 to 10; and
o is an integer from 0 to 5.

16.-22. (canceled)
